(19) United States
(12) Patent Application Publication
(10) Pub. No.: US 2024/0362748 A1
(43) Pub. Date: Oct. 31, 2024

(54) MEDICAL IMAGE OUTPUT APPARATUS, RECORDING MEDIUM, MEDICAL IMAGE OUTPUT METHOD, AND MEDICAL IMAGE OUTPUT SYSTEM

(71) Applicant: KONICA MINOLTA, INC., Tokyo (JP)

(72) Inventor: Ryohei ITO, Tokyo (JP)

(73) Assignee: KONICA MINOLTA, INC., Tokyo (JP)

(21) Appl. No.: 18/613,668

(22) Filed: Mar. 22, 2024

(30) Foreign Application Priority Data
Apr. 28, 2023 (JP) 2023-074433

(51) Int. Cl. G06T 3/60; G06V 20/50

(52) U.S. Cl. CPC G06T 3/60; G06V 20/50; G06T 2210/41; G06V 2201/03

(57) ABSTRACT

A medical image output apparatus includes a hardware processor and an outputter. The hardware processor automatically recognizes a structure of a subject in a medical image and automatically adjusts the medical image based on the recognized structure. The outputter outputs the adjusted medical image.

### BACKGROUND OF THE INVENTION

### Technical Field

The present invention relates to a medical image output apparatus, a recording medium, a medical image output method, and a medical image output system.

### Description of Related Art

In X-ray imaging, a radiologist adjusts (rotates, trims, and centers) an image so that a doctor can easily interpret the image. In this adjustment operation, it is necessary to align images according to a direction determined in a hospital or specified by each doctor. Since the adjustment needs to be performed for each image, the load on the radiologist is very high. In addition, the radiologist needs to pay attention to the patient's pain or waiting time at the time of imaging. There is a limit to adjustment of an image only by position adjustment of the irradiation field or the panel.

In Japanese Unexamined Patent Publication No. 2012-55491, a cutout position of an image can be selected from fixed patterns. However, in Japanese Unexamined Patent Publication No. 2012-55491, it is based on the premise that subjects are captured at positions similar to one another, and is not always suitable for various conditions such as a subject position or inclination that changes for each imaging.

The technology described in Japanese Unexamined Patent Publication No. 2015-150072 can align a cutout position with that in the past imaging, but cannot cope with the subject position, inclination or the like that changes for each imaging.

Meanwhile, it has been found that there is a need to delicately adjust the position or angle of a subject captured in an image according to the rules of each facility. Currently, a radiologist recognizes and positions an object in an image, and then performs adjustment (rotation, trimming and centering) of the image.

### SUMMARY OF THE INVENTION

However, the technologies described in Japanese Unexamined Patent Publication No. 2012-55491 and Japanese Unexamined Patent Publication No. 2015-150072 are those for trimming an object in an image without recognizing the object, and cannot cope with an appropriate cutout position, rotation angle or the like that is different for each imaging.

Furthermore, for a facility (interpreter), images need to be adjusted in accordance with the most appropriate reference(s). For this purpose, it is necessary to recognize the object shown in the image, and there is no other way but to deal with it by a person.

It is conceivable to automatically perform rotation, trimming, or the like on the image. Conventionally, a person recognizes and positions an object in an image and then determines how to rotate and how to trim the image. In order to automatically rotate the image, it is necessary to specify a part, a position thereof, and a shape thereof, such as where an elbow is and what shape it has. That is, even if automatic rotation, trimming, or the like is attempted, how to perform the rotation and how to perform the trimming are unknown.

Therefore, objects of the present invention include reducing the workload of a photographer by automatically adjusting an image.

By the way, in recent years, the image recognition technology has been developed. For example, it has become possible to automatically recognize an object in an image and automatically specify a target part.

The present inventor has conceived that image adjustment can be automatically performed if an object is automatically recognized, and has reached the present invention.

To achieve at least one of the abovementioned objects, according to an aspect of the present invention, a medical image output apparatus reflecting one aspect of the present invention includes:
a hardware processor that automatically recognizes a structure of a subject in a medical image and automatically adjusts the medical image based on the recognized structure; and
an outputter that outputs the adjusted medical image.

According to an aspect of the present invention, a non-transitory computer-readable recording medium reflecting one aspect of the present invention stores a program that causes a computer to:
automatically recognize a structure of a subject in a medical image;
automatically adjust the medical image based on the recognized structure, and
output the adjusted medical image.

According to an aspect of the present invention, a medical image output method reflecting one aspect of the present invention includes:
automatically recognizing a structure of a subject in a medical image;
automatically adjusting the medical image based on the recognized structure; and
outputting the adjusted medical image.

According to an aspect of the present invention, a medical image output system reflecting one aspect of the present invention includes:
a hardware processor that automatically recognizes a structure of a subject in a medical image and automatically adjusts the medical image based on the recognized structure; and
an outputter that outputs the adjusted medical image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a system configuration diagram of a radiographic imaging system in an embodiment of the present invention;

FIG. 2 is a block diagram illustrating a functional configuration of a console;

FIG. 3 is a diagram illustrating an example of a data configuration of a setting table;

FIG. 4 is a diagram for explaining a method of describing an angle on an image;

FIG. 5A is an example of an elbow joint side image;

FIG. 5B shows an automatic rotation reference (pattern A1);

FIG. 5C is a diagram illustrating an automatic rotation reference (pattern A2);

FIG. 6A is an example of a chest front image;

FIG. 6B is a diagram illustrating an automatic trimming reference (pattern B1);

FIG. 6C is a diagram illustrating an automatic trimming reference (pattern B2);

FIG. 7A is an example of a knee joint side image;

FIG. 7B is a diagram illustrating an automatic rotation reference (pattern C1);

FIG. 7C is a diagram illustrating an automatic rotation reference (pattern C2);

FIG. 8A is a diagram illustrating a region of interest recognized from a medical image;

FIG. 8B is a diagram illustrating a medical image whose output size has been automatically adjusted;

FIG. 9 is a flowchart illustrating an imaging control process executed at the console;

FIG. 10 is an example of an examination screen;

FIG. 11 is a flowchart illustrating an automatic adjustment process;

FIG. 12 is an example of an elbow joint side image;

FIG. 13 is an example of an image after the elbow joint side image is automatically rotated;

FIG. 14 is an example of an image after a trimming frame is moved with respect to the rotated image;

FIG. 15 is an example of a preview display screen including an automatically adjusted elbow joint side image;

FIG. 16 is an example of a preview display screen including an automatically adjusted chest front image;

FIG. 17 is an example of an examination screen including an elbow joint side image automatically adjusted based on the pattern A1; and

FIG. 18 is an example of an examination screen including an elbow joint side image automatically adjusted based on the pattern A2.

### DETAILED DESCRIPTION

Hereinafter, one or more embodiments of the present invention will be described with reference to the drawings. However, the scope of the invention is not limited to the disclosed embodiments.

### <Configuration of Radiographic Imaging System>

First, a description is given about a schematic configuration of a radiographic imaging system (hereinafter, system 100) as a medical image output system according to the present embodiment.

FIG. 1 is a system configuration diagram of the system 100.

As illustrated in FIG. 1, the system 100 includes a radiographic imaging apparatus (hereinafter, imaging apparatus 1), a console 2, a radiation generation apparatus (hereinafter, generation apparatus 3), and an image management apparatus 4. The apparatuses 1 to 4 can communicate with each other via a communication network N such as a local area network (LAN), a wide area network (WAN), or the Internet.

Note that the system 100 may be installed in an imaging room or may be configured to be movable (e.g., a medical cart).

Furthermore, the system 100 may be communicable with a not-shown hospital information system (HIS), a not-shown radiology information system (RIS), or the like.

The generation apparatus 3 includes a generator 31, an irradiation instruction switch 32, and a radiation source 33.

The generator 31 applies a voltage corresponding to preset imaging conditions to the radiation source 33 (tube) on the basis of an operation of the irradiation instruction switch 32.

When a voltage is applied from the generator 31, the radiation source 33 generates radiation R (e.g., X-rays or the like) of a dose corresponding to the applied voltage.

Furthermore, the generation apparatus 3 generates the radiation R in a manner corresponding to the form of a radiographic image to be generated. Examples of the form of the radiographic image include a still image and a dynamic image having a plurality of frames.

In the case of a still image, the generation apparatus 3 performs emission of the radiation R only once per press on the emission instruction switch 32.

In the case of a dynamic image, the generation apparatus 3 repeats the emission of the pulsed radiation R a plurality of times per predetermined time (for example, 15 times per second) or continues the emission of the radiation R for a predetermined time, per press on the emission instruction switch 32.

The imaging apparatus 1 generates digital data of a radiographic image in which an imaging part of a subject is imaged.

The imaging apparatus 1 is a portable flat panel detector (FPD).

Specifically, although not illustrated, the imaging apparatus 1 includes a sensor board, a scanning section, a reading section, a controller, a communication part, and the like. On the sensor board, imaging elements and switch elements are arranged two dimensionally (in a matrix). Upon receiving the radiation R, the imaging elements generate charges corresponding to the dose. The switch elements accumulate charges and discharges charges. The scanning section switches ON/OFF of each switch element. The reading section reads, as a signal value, the amount of charge emitted from each pixel. The controller controls each section and generates a radiographic image from the plurality of signal values read by the reading section. The communication part transmits data of a radiographic image, various signals, or the like to other apparatuses (the console 2, the generation apparatus 3, the image management apparatus 4, and the like), and receives various types of information or various signals from the other apparatuses.

The imaging apparatus 1 accumulates and releases charges and reads signal values in synchronization with the timing at which the radiation R is emitted from the generation apparatus 3. In this way, the imaging apparatus 1 generates image data of a still image (hereinafter, still image data) or image data of a dynamic image (hereinafter, dynamic image data).

In the case of generating still image data, the imaging apparatus 1 generates a radiographic image only once per press on the irradiation instruction switch 32.

In the case of generating dynamic image data, the imaging apparatus 1 repeats, a plurality of times per predetermined time (e.g., 15 times per second), generation of a frame constituting a dynamic image per press on the irradiation instruction switch 32.

Note that the imaging apparatus 1 may be integrated with the generation apparatus 3.

The console 2 sets various imaging conditions in at least one of the imaging apparatus 1 and the generation apparatus 3. The console 2 is constituted by a PC, a dedicated device, or the like.

The imaging conditions include, for example, a condition related to the subject S, a condition related to the emission of the radiation R, and a condition related to the image reading of the imaging apparatus 1. The condition related to the subject S includes an imaging part, an imaging direction, a physique, and the like. The condition related to the emission of the radiation R includes a tube voltage, a tube current, an irradiation time, a current-time product (mAs value), and the like. The condition related to image reading of the imaging apparatus 1 includes a frame rate, a frame interval, a pixel size, an image size (matrix size), and the like.

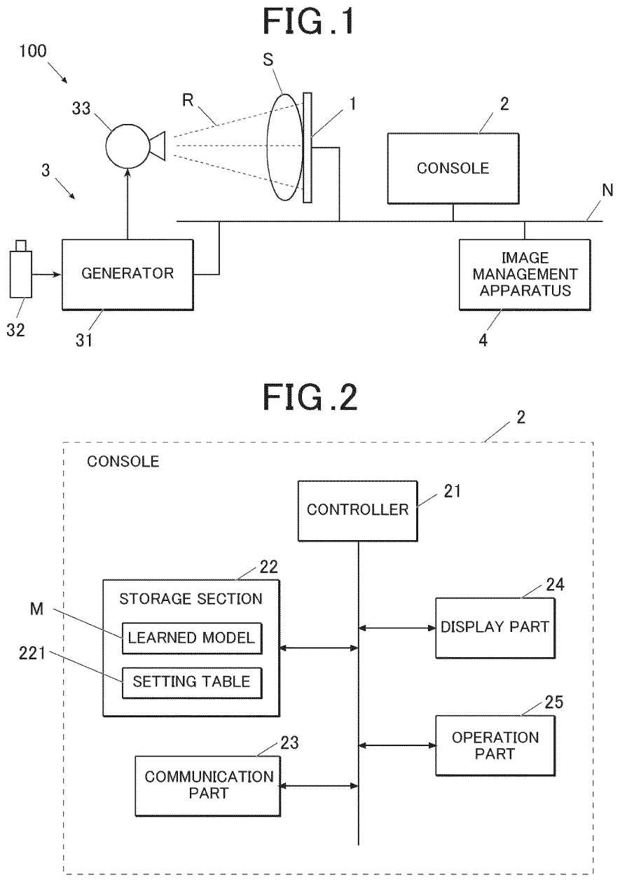

The console 2 may automatically set the imaging conditions based on imaging order information acquired from another system (HIS, RIS, or the like). Furthermore, the console 2 may manually set the imaging conditions on the basis of an operation performed on the operation part 25 (see FIG. 2) by a user (e.g., photographer such as a radiologist).

The image management apparatus 4 manages the image data generated by the imaging apparatus 1.

The image management apparatus 4 is a picture archiving and communication system (PACS), an image diagnostic workstation (IWS), or the like.

### <Detailed Configuration of Console>

Next, the configuration of the console 2 will be described in detail. In the present embodiment, the function of the medical image output apparatus according to the present invention is installed in the console 2. The medical image output apparatus includes a radiographic image display apparatus, an MRI image display apparatus, and an ultrasonic image display apparatus. The radiographic image display apparatus includes a radiographic imaging apparatus, a console of the radiographic imaging apparatus, and a radiographic image management apparatus (PACS).

FIG. 2 is a block diagram illustrating the functional configuration of the console 2.

As illustrated in FIG. 2, the console 2 includes the controller 21 (i.e., hardware processor), a storage section 22 (storage), a communication part 23, a display part 24, and an operation part 25. The components 21 to 25 are electrically connected to each other by a bus or the like.

The controller 21 is configured of a central processing unit (CPU), a random access memory (RAM), a read only memory (ROM), and the like.

The ROM stores various programs to be executed by the CPU, parameters required for execution of the programs, and the like.

The CPU reads various programs stored in the ROM, loads the programs in the RAM, executes various processes in accordance with the programs, and centrally controls the operation of each component of the console 2.

The storage section 22 includes a nonvolatile memory and a hard disk.

Further, the storage section 22 stores image data of a radiographic image acquired from another apparatus (the imaging apparatus 1, the image management apparatus 4, or the like).

The storage section 22 stores a learned model M.

The learned model M is obtained by machine learning (for example, deep learning) of a process of automatically recognizing a structure of a subject in a medical image. The learned model M is generated by machine learning using image data of a radiographic image and a structure (correct label) of a subject in the radiographic image.

When the image data of the radiographic image is input, the learned model M performs inference and outputs information on the structure as output data.

The storage section 22 also stores the imaging order information transmitted from the RIS or the like.

The communication part 23 includes a communication module and the like.

The communication part 23 transmits and receives various signals or various data to and from other apparatuses (the imaging apparatus 1, the generation apparatus 3, the image management apparatus 4, and the like) connected in a wired or wireless manner via the communication network N.

The display part 24 is configured by, for example, a liquid crystal display (LCD), an organic EL display, or the like. The display part 24 displays a radiographic image or the like corresponding to an image signal received from the controller 21.

The operation part 25 includes a keyboard, a pointing apparatus, a touch screen laminated on the surface of the display part 24, and the like. The keyboard includes cursor keys, number input keys, various function keys, and the like. The pointing device is, for example, a mouse or the like. The operation part 25 outputs, to the controller 21, a control signal corresponding to an operation performed by the user.

Note that the console 2 may not include the display part 24 and the operation part 25, and may receive a control signal from an input apparatus provided separately from the console 2 via, for example, the communication part 23. The console 2 may output an image signal to a display apparatus (monitor) provided separately from the console 2.

When another apparatus (the image management apparatus 4 or the like) includes a display part and an operation part, the display part and the operation part may be shared with the console 2. That is, the console 2 may receive a control signal from an operation part of another apparatus and output an image signal to a display part of another/the other apparatus.

The controller 21 automatically recognizes a structure of a subject in a medical image. The controller 21 functions as a recognition section. Specifically, for example, the controller 21 analyzes a medical image and recognizes an object in the image. The controller 21 (recognition section) may automatically recognize a structure of the subject in a medical image by image processing such as edge extraction or histogram analysis.

The medical image includes a radiographic image, an MRI image, and an ultrasonic image. In the present embodiment, a case where the medical image is a radiographic image will be described.

The structure of the subject may include a target part or an imaging part of the subject, and may include a jig or a marker for positioning. The structure of the subject is preferably a target part or an imaging part of the subject.

The controller 21 may automatically recognize a structure of a subject in a medical image by using the learned model M obtained by machine learning. The learned model M includes, for example, an algorithm (program) and learned parameters.

According to the learned model M, for example, even if a joint is an artificial joint or a bone is partially lost due to fracture or the like, it is easy to automatically recognize a structure of a subject in a medical image. Since the recognition accuracy is improved, the accuracy with which the adjusted medical image is correctly output is also improved.

The controller 21 automatically adjusts the medical image on the basis of the recognized structure. The controller 21 functions as an adjustment section.

The automatic adjustment of the medical image includes adjustment of rotation or a display range of the medical image. The adjustment of the display range includes trimming.

The automatic adjustment of the medical image includes at least one of adjustment of a rotation angle of the medical image, position adjustment of a rotation center of the medical image, adjustment of trimming of the medical image, and position adjustment of a trimming center of the medical image.

The adjustment of trimming is adjustment of a trimming size or adjustment of a trimming position.

The positional adjustment of the trimming center is positional adjustment of a position serving as the center in the X-axis direction or position adjustment of a position serving as the center in the Y-axis direction when the medical image is trimmed. Here, the X-axis direction is, for example, a right-left direction or a horizontal direction. The Y-axis direction is, for example, an up-down direction or a vertical direction.

The adjustment of the rotation angle of the medical image includes correction of inclination of the medical image.

The controller 21 (adjustment section) determines an automatic adjustment reference which is a reference for automatically adjusting the medical image, based on the recognized structure or the imaging order information on the medical image.

The automatic adjustment reference for the medical image includes at least one of a reference for adjustment of a rotation angle of the medical image, a reference for position adjustment of a rotation center of the medical image, a reference for adjustment of trimming of the medical image, and a reference for position adjustment of a trimming center of the medical image.

The reference for the adjustment of the rotation angle includes, for example, a display mode or shape of the imaging part as an imaging target when the medical image is rotated. The reference for the adjustment of the rotation angle includes a display mode or shape serving as a sample of the adjustment of the rotation angle.

The automatic adjustment reference is information indicating the shape of the imaging part as the imaging target or the anatomical part of the imaging part. The automatic adjustment reference may include information indicating a final display mode serving as a reference when the medical image is rotated or trimmed.

For example, when a predetermined rotation angle pattern (a pattern A1, A2, or the like to be described later) is selected in an item of the reference for the rotation of the medical image, the medical image is rotated so as to be displayed in the state of the rotation angle pattern, and thus the display image is determined. Furthermore, for example, when the vertebral body center is selected in an item of the trimming reference (X-axis direction) for the medical image, the trimming is performed so that the vertebral body is located at the center in the medical image, and the display image is determined.

The storage section 22 stores, for each imaging part as the imaging target, the imaging part as the imaging target in association with whether or not to automatically adjust the medical image. That is, in the storage section 22, whether or not to automatically adjust the medical image is set in association with the imaging part of the medical image. For example, in the case of the setting of the automatic adjustment, it is possible to further set whether to perform adjustment of rotation or whether to perform adjustment of trimming. In some cases, whether or not the automatic adjustment is performed is stored in association with each imaging part, and in other cases, whether or not the automatic adjustment is performed is stored in association with each information on the imaging part and the imaging direction.

The automatic adjustment of the medical image may have a plurality of items. In that case, the storage section 22 stores, for each imaging part as the imaging target, an imaging part as the imaging target in association with whether or not to perform each item of the plurality of items of the automatic adjustment.

The controller 21 (adjustment section) refers to the correspondence relationship stored in the storage section 22, and determines whether to perform the automatic adjustment, based on the imaging part as the imaging target which is the recognized structure or the imaging order information on the medical image. Here, the correspondence relationship is a correspondence relationship between the imaging part and whether or not to perform the automatic adjustment.

If the automatic adjustment of the medical image has a plurality of items, the controller 21 (adjustment section) refers to the correspondence relationship stored in the storage section 22, and determines whether to perform each item of the plurality of items of the automatic adjustment, based on the imaging part as the imaging target, the imaging part being the recognized structure, or the imaging order information on the medical image.

The storage section 22 stores, for each imaging part as the imaging target, an imaging part as the imaging target in association with an automatic adjustment reference that is a reference for automatically adjusting a medical image. That is, in the storage section 22, the automatic adjustment reference for the medical image is set in association with the imaging part of the medical image.

The automatic adjustment reference may have a plurality of items. In that case, the storage section 22 stores, for each imaging part as the imaging target, an imaging part as the imaging target in association with each item of the plurality of items of the automatic adjustment reference.

The controller 21 (adjustment section) refers to the correspondence relationship stored in the storage section 22, and determines the automatic adjustment reference based on the imaging part as the imaging target, the imaging part being the recognized structure, or the imaging order information on the medical image. Here, the correspondence relationship is a correspondence relationship between the imaging part and the automatic adjustment reference.

If the automatic adjustment reference has a plurality of items, the controller 21 (adjustment section) refers to the correspondence relationship stored in the storage section 22, and determines each item of the plurality of items of the automatic adjustment reference based on the imaging part as the imaging target, the imaging part being the recognized structure, or the imaging order information on the medical image.

In one embodiment, the medical image output apparatus includes a display part for displaying the automatically adjusted medical image. The display part 24 of the console 2 is an embodiment of an output part (outputter) that outputs the adjusted medical image.

Furthermore, in another embodiment, the medical image output apparatus may include a storage section that stores the automatically adjusted medical image, and may include a display part that displays the stored medical image. This embodiment is a pattern in which an image after adjustment is saved in advance and the image after adjustment is displayed.

Furthermore, in another embodiment, the medical image output apparatus may include a storage section that stores information on an angle and a position of the automatic adjustment, and may include a display part that displays a display image based on the information on the angle and the position of the automatic adjustment. This embodiment is a pattern in which information on the angle and position of adjustment is saved, and adjustment is performed at the timing of display.

Furthermore, in another embodiment, the medical image output apparatus may include an output part to output at least one of the automatically adjusted medical image, the automatically adjusted and stored medical image, and the information on the angle and position of the automatic adjustment to another apparatus.

The storage section 22 stores a setting table 221. In the setting table 221, whether or not a medical image is automatically adjusted and an automatic adjustment reference(s) for the medical image are set for each imaging part. The setting table 221 can be set, for example, for each medical facility using the system 100. Furthermore, the setting table 221 may be set for each user (healthcare professional such as a doctor) or each group to which a user belongs.

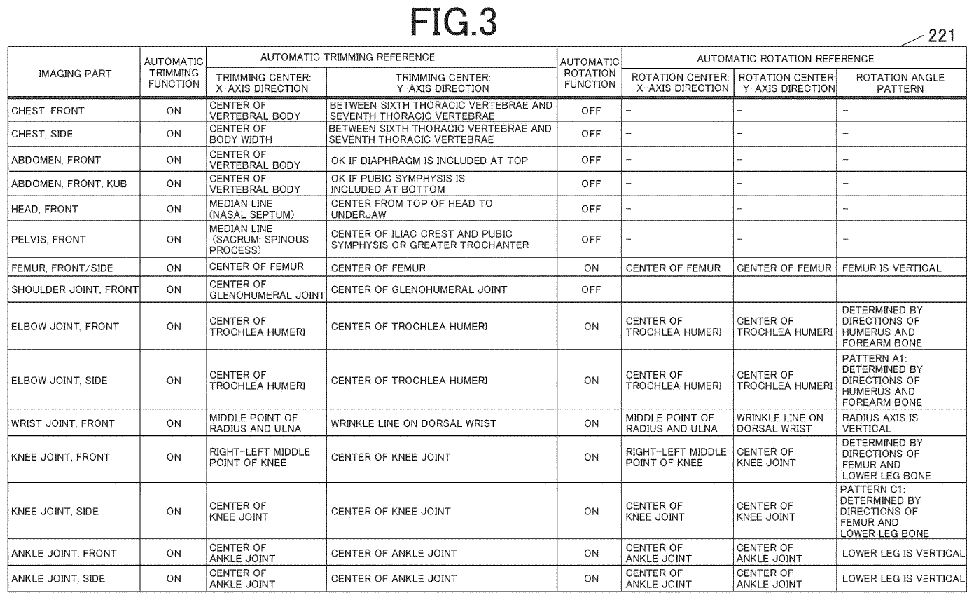

FIG. 3 shows an example of the data configuration of the setting table 221.

In the setting table 221 illustrated in FIG. 3, ON/OFF of the automatic trimming function, the automatic trimming reference, ON/OFF of the automatic rotation function, and the automatic rotation reference are associated with each imaging part. Here, the imaging part includes an imaging direction.

The ON/OFF of the automatic trimming function is information indicating whether to perform the automatic adjustment related to trimming of a medical image. In a case where the automatic adjustment regarding trimming is performed, “ON” is set, and in a case where the automatic adjustment regarding trimming is not performed, “OFF” is set. Note that the trimming adjustment is not limited to removal of the outside of the predetermined range of the medical image, but includes adjustment of a display range or a display position of the medical image.

The automatic trimming reference is the automatic adjustment reference related to trimming of a medical image. The automatic trimming reference includes, for example, the center position of trimming (X-axis direction and Y-axis direction). Only one of the two directions (the X-axis direction and the Y-axis direction) may be specified as the center position of trimming. Further, as the automatic trimming reference, a positional relationship with which a predetermined structure is included in the medical image may be specified. For example, a positional relationship such as “OK if the diaphragm is included at the top” may be specified as the automatic trimming reference in the Y-axis direction for the imaging part “abdomen, front”.

The ON/OFF of the automatic rotation function is information indicating whether to perform the automatic adjustment related to the rotation of the medical image. In a case where the automatic adjustment related to rotation is performed, “ON” is set, and in a case where the automatic adjustment related to rotation is not performed, “OFF” is set.

The automatic rotation reference is the automatic adjustment reference related to the rotation of the medical image. The automatic rotation reference includes, for example, a center position of rotation (in each of X-axis direction and Y-axis direction) and a rotation angle pattern. The center position of rotation is a position of a rotation axis when the medical image is rotated. The rotation angle pattern is, for example, information indicating a desired positional relationship with which an image is displayed (target rotation state).

For example, in the setting table 221 shown in FIG. 3, the trimming center in the X-axis direction (right-left direction) is set to “the center of the vertebral body (spine)” and the trimming center in the Y-axis direction (up-down direction) is set to “between the 6^{th} thoracic vertebrae and the 7^{th} thoracic vertebrae”, with respect to the imaging part “chest, front”.

However, there may be a policy that the position adjustment is not performed in the Y-axis direction in order to make it possible to check the entire imaged subject. Therefore, it may be possible to separately set ON/OFF for trimming (centering) in the Y-axis direction.

Further, the rotation function is not generally used for the imaging part “chest, front” because a degree of bending of the backbone or the like becomes unclear.

Note that regarding the automatic adjustment reference, in the case where a plurality of patterns (references) is present for the same imaging part in general, pattern options (candidates) are presented to the user at the time of setting by the user, so that the user can select one from among the options.

### Example of Automatic Adjustment

As an example of the automatic adjustment, automatic rotation and automatic trimming for an “elbow joint side image” will be described.

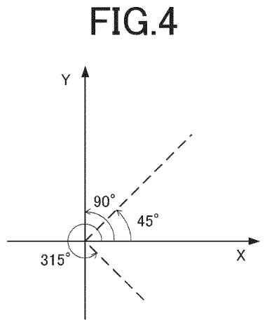

Hereinafter, in the description of the angle on the image, as illustrated in FIG. 4, the positive direction of the X axis is set to 0 degrees with the origin of the XY plane as the center, and the angle is taken counterclockwise.

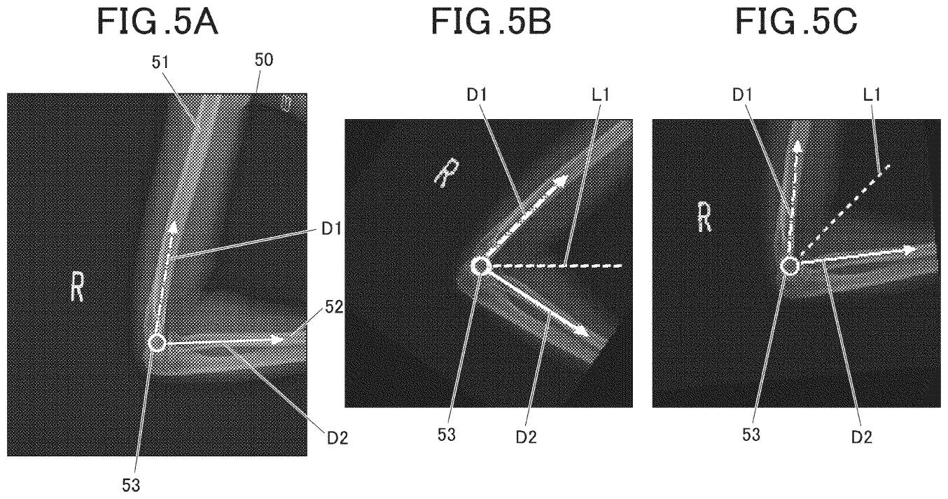

FIG. 5A shows an example of an elbow joint side image 50.

In the elbow joint side image 50, a humerus 51, a forearm bone 52 (ulna and radius), and a joint movable portion (trochlea humeri 53) on the humerus side are shown. The elbow joint side image 50 is adjusted such that the humerus 51 and the forearm bone 52 are at a predetermined angle with the trochlea humeri 53 as the center. There are at least two patterns of the rotation angle.

In the case of the right arm, as illustrated in FIG. 5B, a rotation angle where the humerus direction D1 is oriented to the 45° direction and the forearm bone direction D2 is oriented to the 315° direction in a state where the elbow joint is bent substantially 90° is referred to as a “pattern A1”. In the case of the left arm, the “pattern A1” is in a state in which the humerus direction D1 is the 135° direction and the forearm bone direction D2 is the 225° direction. Furthermore, in the case of the right arm, as illustrated in FIG. 5C, a rotation angle where the humerus direction D1 is oriented to the 90° direction and the forearm bone direction D2 is oriented to the 0° direction in a state where the elbow joint is bent substantially 90° is referred to as a “pattern A2”. In the case of the left arm, the “pattern A2” is in a state where the humerus direction D1 is oriented to the 90° direction and the forearm bone direction D2 is oriented to the 180° direction.

Which of the “pattern A1” and the “pattern A2” is used as a reference for rotation can be changed in advance by setting.

In addition, the image position is adjusted such that the trochlea humeri 53 is at the center of the image.

An automatic adjustment method for the “elbow joint side image” will be described.
(1) In the elbow joint side image 50, the position of the center of the recognized trochlea humeri 53 (the center of rotation of the image) is calculated.
(2) The angular directions of the humerus 51 and the forearm bone 52 with the rotation center as the origin are calculated.
(3) A bisector L1 of an angle formed by the humerus direction D1 and the forearm bone direction D2 is obtained (see FIG. 5B and FIG. 5C).
(4) When the “pattern A1” is set as the automatic rotation reference, the image is rotated such that the bisector L1 is oriented to the 0° direction with respect to the “elbow joint side image” of the right arm, as shown in FIG. 5B. When the “pattern A2” is set as the automatic rotation reference, the image is rotated such that the bisector L1 is oriented to the 45° direction with respect to the “elbow joint side image” of the right arm, as shown in FIG. 5C.

Note that in the “elbow joint side image”, when the angle at which the elbow joint is bent is not substantially 90°, the image is rotated such that only the humerus direction D1 is in the 90° direction.

Next, the automatic trimming for a “chest front image” will be described.

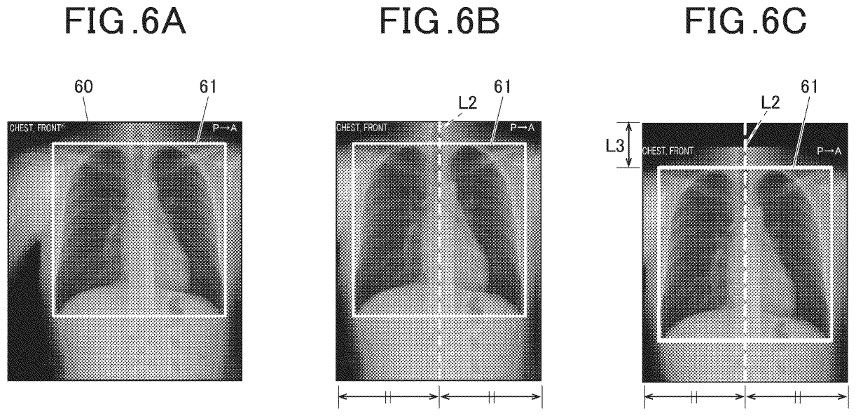

FIG. 6A shows an example of a chest front image 60.

The chest front image 60 includes the lung fields, vertebral body, and the like. The position of the chest front image 60 is adjusted such that the center (vertebral body) of the lung fields in the right-left direction is located at the center of the image in the right-left direction (X-axis direction).

As for the up-down direction (Y-axis direction) of the image of the chest front image 60, there are cases where no adjustment is made, the positions of the pulmonary apexes (upper ends of the lung fields) are aligned, the position of a predetermined structure is set as the image center, and the like.

As illustrated in FIG. 6B, a state in which trimming is performed such that the center L2 of the lung fields in the right-left direction becomes the center of the image in the right-left direction is referred to as a “pattern B1”.

As illustrated in FIG. 6C, a state in which trimming is performed such that the center L2 of the lung fields in the right-left direction becomes the center of the image in the right-left direction and the pulmonary apexes are located at a predetermined value L3 (e.g., several centimeters) from the upper end of the image region is referred to as a “pattern B2”.

Although not illustrated, as the position of the predetermined structure, for example, the position between the 6^{th} thoracic vertebrae and the 7^{th} thoracic vertebrae may be adjusted to be the center of the image in the up-down direction.

The positions in the horizontal direction and the vertical direction of the image are adjusted based on the set references.

An automatic adjustment method for the “chest front image” will be described.
(1) As illustrated in FIG. 6A, a rectangular region 61 including the recognized lung fields is detected as a region of interest (ROI) in the chest front image 60.
(2) The position of the image is adjusted such that the center L2 of the rectangular region 61 in the right-left direction is the center of the image in the right-left direction (see FIGS. 6B and 6C).
(3) In a case where the positions of the pulmonary apexes are specified in the up-down direction, as illustrated in FIG. 6C, adjustment is performed such that the upper end of the rectangular region 61 is located at a position away from the upper end of the image region by a predetermined value L3.

Note that here, it is assumed that the center L2 (the center of the rectangular region 61) of the lung fields in the right-left direction matches the center of the vertebral body. The center position of the vertebral body may be obtained by automatically recognizing the vertebral body from the chest front image 60.

Next, the automatic rotation and the automatic trimming for a “knee joint side image” will be described.

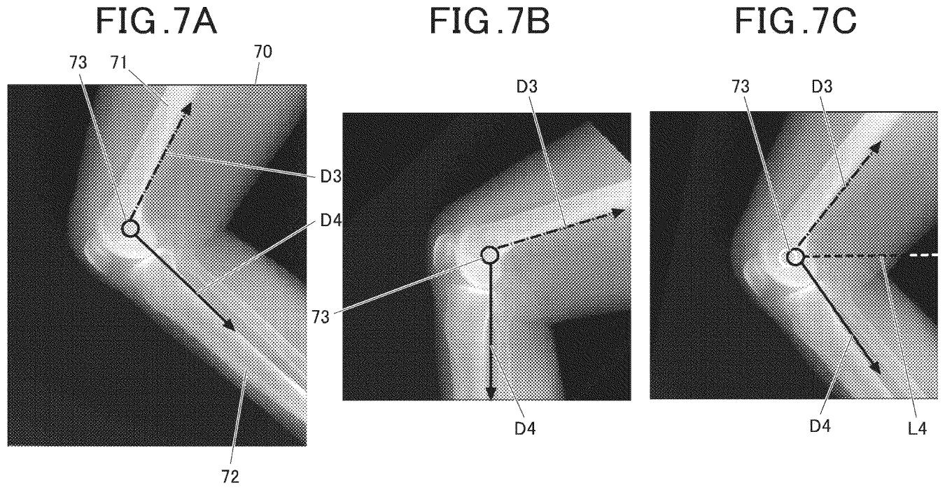

FIG. 7A illustrates an example of a knee joint side image 70.

A femur 71, a lower leg bone 72 (tibia and fibula), and a femoral condyle appear in the knee joint side image 70. The knee joint side image 70 is adjusted such that the femur 71 and the lower leg bone 72 form a predetermined angle with the femoral condyle center 73 as the center. Here, the femoral condyle center 73 is used as the “center of the knee joint” of the center of rotation. There are at least two patterns of the rotation angle.

As shown in FIG. 7B, a rotation angle at which the lower leg bone direction D4 is oriented to the 270° direction (downward direction) is referred to as a “pattern C1”.

Further, in the case of the right knee, as shown in FIG. 7C, a rotation angle at which a bisector L4 of an angle formed by the femur direction D3 and the lower leg bone direction D4 is oriented to the 0° direction is referred to as a “pattern C2”. In the case of the left knee, the “pattern C2” is in a state in which the bisector L4 of the angle formed by the femur direction D3 and the lower leg bone direction D4 is oriented to the 180° direction.

Which of the “pattern C1” and the “pattern C2” is used as a reference for rotation can be changed in advance by setting.

Further, the image position is adjusted such that the femoral condyle center 73 becomes the center of the image.

An automatic adjustment method for the “knee joint side image” will be described.
(1) In the knee joint side image 70, the position of the recognized femoral condyle center 73 (the rotation center of the image) is calculated.
(2) The angular directions of the femur 71 and the lower leg bone 72 with the rotation center as the origin are calculated.
(3) When the “pattern C2” is set as the automatic rotation reference, a bisector L4 of an angle formed by the femur direction D3 and the lower leg bone direction D4 is obtained.
(4) When the “pattern C1” is set as the automatic rotation reference, as illustrated in FIG. 7B, the image is rotated such that the lower leg bone direction D4 is oriented to the 270° direction with respect to the “knee joint side image”. In a case where the “pattern C2” is set as the automatic rotation reference, as illustrated in FIG. 7C, the image is rotated such that the bisector L4 is oriented to the 0° direction with respect to the “knee joint side image” of the right knee. When the “pattern C2” is set as the automatic rotation reference, the image is rotated such that the bisector L4 is oriented to the 180° direction with respect to the “knee joint side image” of the left knee.

Further, in the automatic trimming adjustment, when the ROI recognized from the medical image is larger than the output size of the image, the output size may be automatically changed.

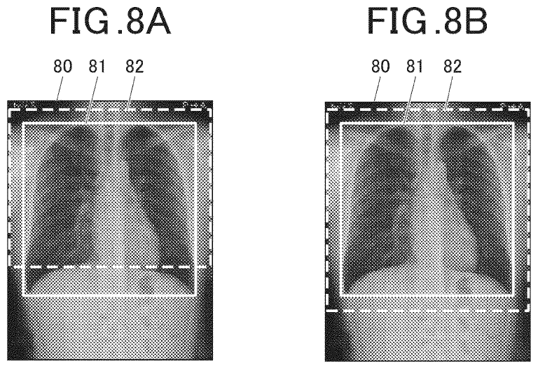

For example, as shown in FIG. 8A, it is assumed that an ROI 81 is recognized from the entire medical image 80. The output size 82 is a big square (14×14 inches), while the height of the ROI 81 is 15 inches. In this case, as illustrated in FIG. 8B, the height of the output size 82 is automatically changed to be equal to or larger than 15 inches.

### <Operation of Console>

Next, the operation of the console 2 will be described.

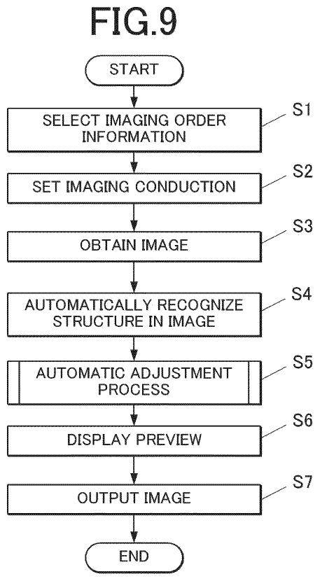

FIG. 9 is a flowchart illustrating an imaging control process executed at the console 2. The imaging control process is executed by the CPU of the controller 21 in cooperation with a program stored in the ROM.

First, the controller 21 receives selection of (a piece of) the imaging order information on imaging to be performed (imaging part, imaging direction) by an operation from the operation part 25 (Step S1).

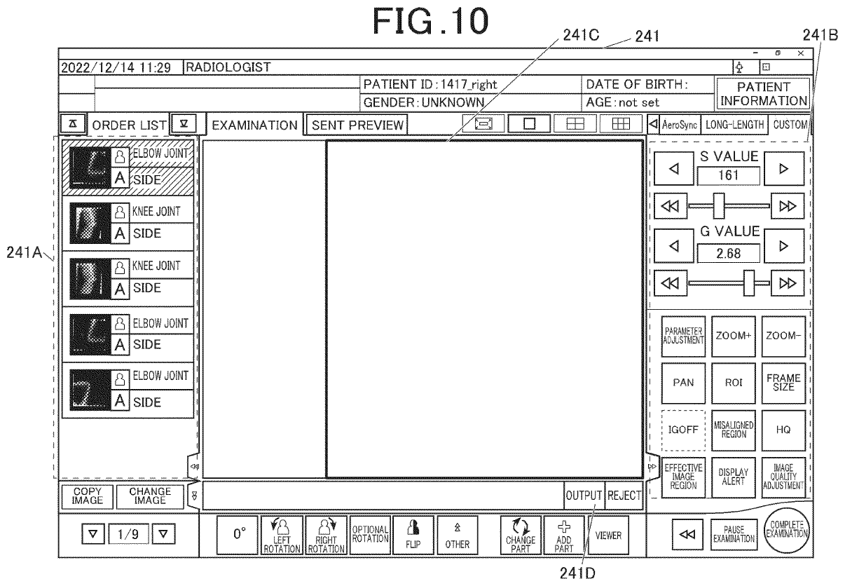

FIG. 10 shows an example of an examination screen 241 displayed on/by the display part 24. The examination screen 241 is provided with an imaging selection region 241A, a setting region 241B, an image display region 241C, an output button 241D, and the like.

In the imaging selection region 241A, the contents (imaging part, imaging direction, and the like) of each imaging corresponding to each imaging order information is displayed.

The setting region 241B is a region for setting image reading conditions or an image processing conditions for imaging.

A captured radiographic image is displayed in the image display region 241C. Note that in Step S1, a radiographic image has not yet been displayed in the image display region 241C.

The output button 241D is a button for making an instruction to output a radiographic image.

The user (radiographer such as a radiologist) operates the operation part 25 to select one of pieces of the imaging order information in the imaging selection region 241A on the examination screen 241.

Next, the controller 21 sets imaging conditions in the imaging apparatus 1 and the generation apparatus 3 (Step S2).

For example, the controller 21 automatically sets the imaging conditions in the imaging apparatus 1 and the generation apparatus 3 based on the selected imaging order information.

Alternatively, the controller 21 may set the imaging conditions for the imaging to be performed in the imaging apparatus 1 and the generation apparatus 3 in response to a user operation(s) on the examination screen 241 through the operation part 25.

Next, the user arranges the subject S between the radiation source 33 of the generation apparatus 3 and the imaging apparatus 1, and performs positioning.

Then, when the user operates the irradiation instruction switch 32, the generation apparatus 3 irradiates the imaging part of the subject S with the radiation R.

The imaging apparatus 1 generates a radiographic image (a still image or a dynamic image) in which the imaging part is captured at the timing at which the radiation R is received from the generation apparatus 3. The imaging apparatus 1 transmits image data (still image data and dynamic image data) of the radiographic image to the console 2.

The controller 21 of the console 2 acquires the image data of the radiographic image generated by the imaging via the communication part 23 (Step S3).

Next, the controller 21 analyzes the image data of the radiographic image and automatically recognizes a structure(s) of the subject in the radiographic image (Step S4). For example, the controller 21 reads the learned model M and automatically recognizes the structure in the radiographic image. The controller 21 inputs the image data of the received radiographic image to the learned model M and causes the learned model M to perform inference, thereby outputting the recognition result of the structure.

The learned model M outputs, for example, an imaging part, an imaging direction, the name and position of a bone, the name and position of an organ, and/or the like as the recognition result of the structure.

Next, the controller 21 performs an automatic adjustment process on the radiographic image on the basis of the recognized structure (Step S5).

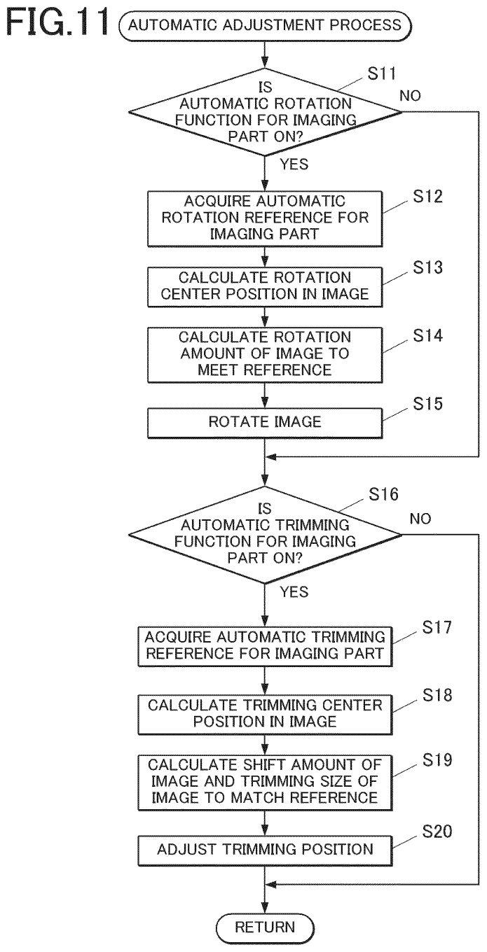

Here, the automatic adjustment process will be described with reference to FIG. 11.

The controller 21 determines, referring to the setting table 221 stored in the storage section 22, whether or not the automatic rotation function for the imaging part in the radiographic image is ON (Step S11).

The imaging part in the radiographic image may be information automatically recognized from the radiographic image in Step S4, or may be information included in the imaging order information selected in Step S1.

If the automatic rotation function for the imaging part in the radiographic image is ON (Step S11; YES), the controller 21 acquires the automatic rotation reference for the imaging part in the radiographic image from the setting table 221 (Step S12). The automatic rotation reference includes a rotation center(s) of an image and a rotation angle pattern.

Next, the controller 21 calculates, on the basis of the rotation center included in the automatic rotation reference and the structure recognized from the radiographic image, a position in the radiographic image on which the image is to be rotated (rotation center position) (Step S13).

Next, the controller 21 calculates the rotation amount of the image such that the radiographic image meets the automatic rotation reference (Step S14). For example, the controller 21 calculates the rotation amount for arranging the radiographic image in accordance with the rotation angle pattern, based on the rotation angle pattern included in the automatic rotation reference and the structure recognized from the radiographic image.

Next, the controller 21 rotates the radiographic image with the rotation center position as the center by the calculated rotation amount (Step S15).

After Step S15 or if the automatic rotation function for the imaging part in the radiographic image is not ON in Step S11 (Step S11; NO), the process proceeds to Step S16.

In Step S16, the controller 21 determines whether the automatic trimming function for the imaging part in the radiographic image is ON.

If the automatic trimming function for the imaging part in the radiographic image is ON (Step S16; YES), the controller 21 acquires the automatic trimming reference for the imaging part in the radiographic image from the setting table 221 (Step S17).

Next, based on the trimming center(s) included in the automatic trimming reference and the structure recognized from the radiographic image, the controller 21 calculates a position in the radiographic image with which the image is trimmed as the center (trimming center position) (Step S18).

Next, the controller 21 calculates the shift amount and the trimming size of the image such that the radiographic image meets the automatic trimming reference (Step S19). For example, the controller 21 calculates the shift amount and the trimming size for arranging the radiographic image in accordance with the automatic trimming reference, on the basis of the automatic trimming reference and the structure recognized from the radiographic image.

Next, the controller 21 adjusts the trimming position of the radiographic image (Step S20). The controller 21 adjusts the trimming position in accordance with the trimming center position, the shift amount, and the trimming size.

After Step S20 or if the automatic trimming function for the imaging part in the radiographic image is not ON (Step S16; NO), the automatic adjustment process ends.

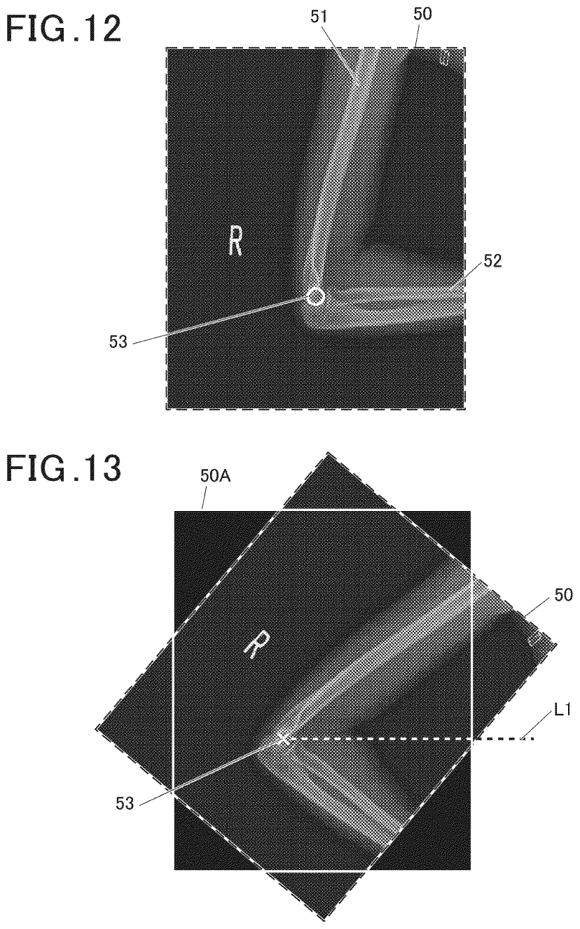

Here, a specific example of the automatic recognition and the automatic adjustment of a structure(s) will be described with reference to FIGS. 12 to 14.

If the elbow joint side image 50 shown in FIG. 12 is to be processed, the controller 21 recognizes the humerus 51, the forearm bone 52, the trochlea humeri 53, and the like from the elbow joint side image 50 in Step S4. Furthermore, based on the humerus 51, the forearm bone 52, the trochlea humeri 53, and the like recognized from the image, the controller 21 recognizes that the imaging part in the elbow joint side image 50 is the “elbow joint, side” of the “right arm”.

Here, it is assumed that, in the setting table 221, the automatic rotation function is set to “ON”, the rotation centers in the X-axis direction and the Y-axis direction are set to “center of trochlea humeri”, and the rotation angle pattern is set to “pattern A1 (see FIG. 5B)”, for the imaging part “elbow joint, side”.

In addition, it is assumed that, in the setting table 221, the automatic trimming function is set to “ON” and the trimming centers in the X-axis direction and the Y-axis direction are set to “center of trochlea humeri”, for the imaging part “elbow joint, side”.

In Step S15, as shown in FIG. 13, the controller 21 rotates the elbow joint side image 50 such that the bisector L1 of the angle formed by the humerus direction and the forearm bone direction is oriented to the 0° direction with the trochlea humeri 53 as the center, thereby being a rotated image 50A.

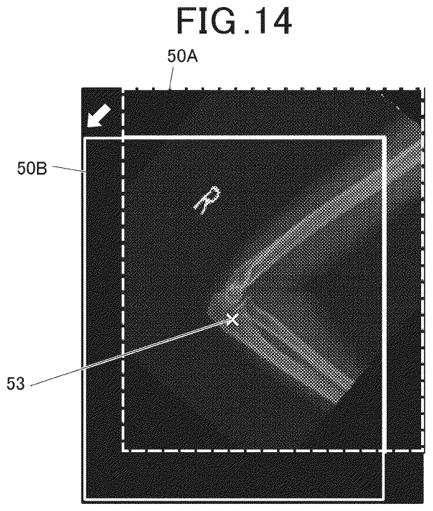

In Step S20, as shown in FIG. 14, regarding the rotated image 50A, the controller 21 moves the trimming frame such that the center of a trimming frame 50B coincides with the trochlea humeri 53.

After the automatic adjustment process, returning to FIG. 9, the controller 21 displays a preview of the automatically adjusted radiographic image on the display part 24 (Step S6).

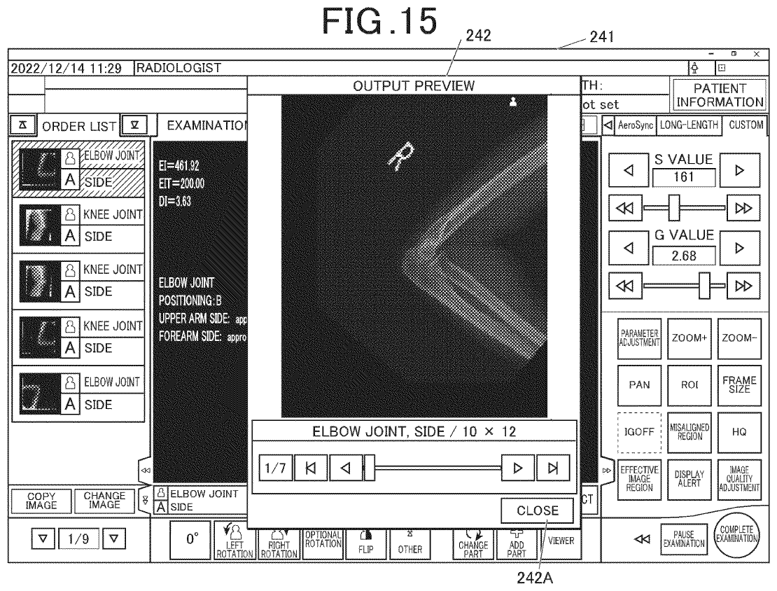

FIG. 15 illustrates an example of a preview display screen 242 displayed on the display part 24. The preview display screen 242 is overlapped and displayed on the examination screen 241. On the preview display screen 242, an automatically adjusted elbow joint side image is displayed. The elbow joint side image has been automatically rotated so as to match the pattern A1 (see FIG. 5B), and automatically trimmed such that the center of the trochlea humeri is the center of the image.

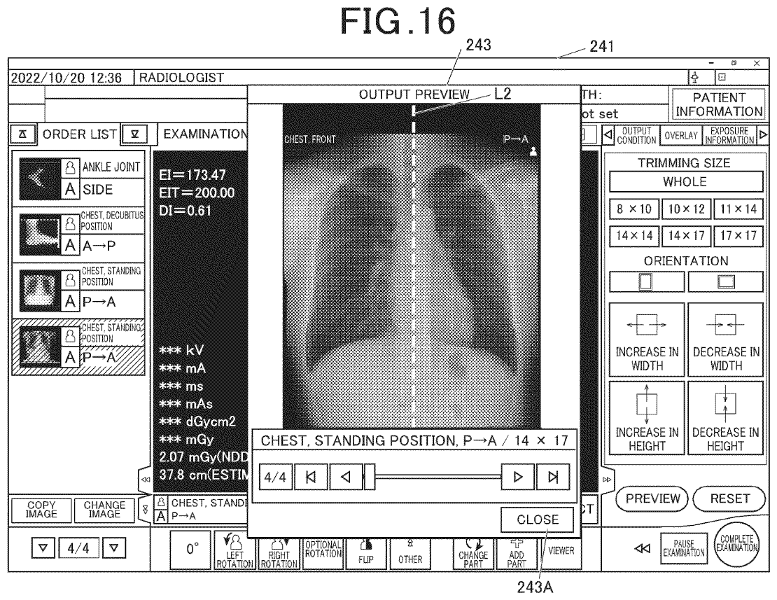

FIG. 16 shows an example of another preview display screen 243 displayed on the display part 24. The preview display screen 243 is overlapped and displayed on the examination screen 241. On the preview display screen 243, an automatically adjusted chest front image (chest, standing position) is displayed.

Note that it is assumed that, in the setting table 221, for the imaging part “chest, front”, the automatic trimming function is set to “ON”, the trimming center in the X-axis direction is set to “center of vertebral body”, and the trimming center in the Y-axis direction is set to “none (−)”.

Furthermore, it is assumed that, in the setting table 221, the automatic rotation function is set to “OFF” for the imaging part “chest, front”.

The chest front image in the preview display screen 243 has been automatically trimmed such that the center of the vertebral body (the center L2 of the lung fields in the right-left direction) is the center of the image in the X-axis direction.

Here, although the image after the automatic adjustment is displayed when the radiographic image is captured by the console 2 (initial display), the controller 21 may perform the automatic rotation adjustment and the automatic trimming adjustment of the image at any timing. For example, in a state where the radiographic image before the adjustment is displayed, the image after the automatic adjustment may be displayed in response to a predetermined operation (press on an automatic adjustment button or the like) by the user.

Furthermore, the timing at which the image after the automatic adjustment is displayed may be able to be set in advance from “initial display”, “at the time of pressing a button”, and the like. This setting can also be changed for each facility and/or each user.

The user checks the previewed radiographic image after the automatic adjustment. For example, the user presses the close button 242A/243A (see FIGS. 15 and 16) of the preview display screen 242/243 by an operation from the operation part 25. Then, the controller 21 displays the previewed radiographic image after the automatic adjustment in the image display region 241C (see FIG. 10) of the examination screen 241.

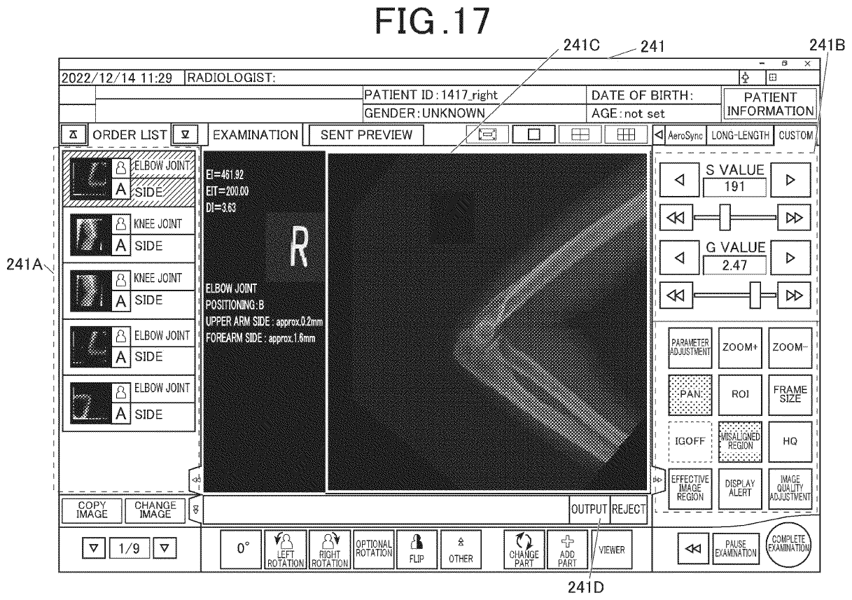

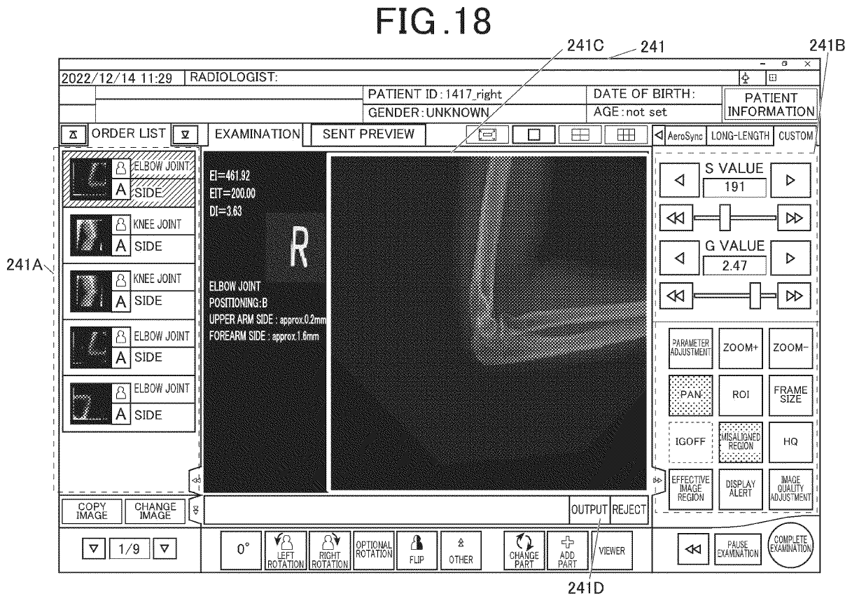

FIGS. 17 and 18 illustrate display examples in a case in which a radiographic image after the automatic adjustment is displayed in the image display region 241C of the examination screen 241. The screen configuration of the examination screen 241 shown in FIGS. 17 and 18 is the same as that shown in FIG. 10.

In the image display region 241C illustrated in FIG. 17, an elbow joint side image is displayed which has been automatically rotated so as to match the pattern A1 (refer to FIG. 5B) and which has been automatically trimmed such that the center of the trochlea humeri is the image center.

In FIG. 18, it is assumed that, in the setting table 221, the automatic rotation function is set to “ON”, the rotation centers in the X-axis direction and the Y-axis direction are set to “center of trochlea humeri”, and the rotation angle pattern is set to the “pattern A2 (see FIG. 5C)”, for the imaging part “elbow joint, side”.

In addition, it is assumed that, in the setting table 221, the automatic trimming function is set to “ON” and the trimming centers in the X-axis direction and the Y-axis direction are set to “center of trochlea humeri”, for the imaging part “elbow joint, side”.

In the image display region 241C shown in FIG. 18, an elbow joint side image which has been automatically rotated so as to match the pattern A2 (see FIG. 5C) and automatically trimmed such that the center of the trochlea humeri becomes the image center is displayed.

The user may further manually adjust the automatically adjusted radiographic image by an operation from the operation part 25.

When the user presses the output button 241D (refer to FIGS. 17 and 18) of the examination screen 241 by an operation from the operation part 25, the controller 21 outputs the radiographic image displayed in the image display region 241C (Step S7). For example, the controller 21 causes the storage section 22 to store the automatically adjusted radiographic image. Alternatively or additionally, the controller 21 transmits the automatically adjusted radiographic image to the image management apparatus 4 via the communication part 23.

This is the end of the imaging control process.

As described above, the controller 21 of the console 2 automatically recognizes a structure(s) of a subject in a medical image, and automatically adjusts the medical image on the basis of the recognized structure. This eliminates the need for the user to manually adjust the medical image. The controller 21 can always output an image stably adjusted at a certain level regardless of the skill of the user (photographer such as a radiologist). According to the controller 21, it is possible to reduce the workload of a photographer by automatically adjusting an image. Since images with uniform arrangement of a subject can be obtained in a medical facility or the like, interpretation thereof can be easy.

For example, the controller 21 can perform adjustment of the rotation angle of the medical image, position adjustment of the rotation center of the medical image, adjustment of trimming of the medical image, position adjustment of the trimming center of the medical image, and the like.

Further, the controller 21 can determine the automatic adjustment reference based on the recognized structure or the imaging order information on the medical image.

Specifically, the controller 21 can determine the reference for adjustment of the rotation angle of the medical image, the reference for position adjustment of the rotation center of the medical image, the reference for adjustment of the trimming of the medical image, the reference for position adjustment of the trimming center of the medical image, and the like.

For example, by using, as the automatic adjustment reference, information indicating the shape of the imaging part as the imaging target or the anatomical part of the imaging part, a display mode serving as a sample for adjustment or a target arrangement state of the medical image can be set.

Further, since the imaging part as the imaging target and whether or not to automatically adjust the medical image are associated with each other in the storage section 22, the controller 21 can determine whether or not to automatically adjust the medical image based on the imaging part.

Here, if a structure recognized in a medical image is used as the imaging part to be used to determine whether or not to perform the automatic adjustment, the controller 21 can determine whether or not to perform the automatic adjustment based on the information obtained from the medical image.

If information included in the imaging order information is used as the imaging part to be used to determine whether or not to perform the automatic adjustment, the controller 21 can determine whether or not to perform the automatic adjustment based on the information set at the time of imaging.

Further, the controller 21 can determine, for each item of the items such as the automatic rotation function and the automatic trimming function, whether to perform the automatic adjustment on the basis of the imaging part.

Further, since the imaging part as the imaging target and the automatic adjustment reference are associated with each other in the storage section 22, the controller 21 can determine the automatic adjustment reference on the basis of the imaging part.

Here, in a case where a structure recognized in a medical image is used as the imaging part to be used to determine the automatic adjustment reference, the controller 21 can determine the automatic adjustment reference based on the information obtained from the medical image.

In a case where information included in the imaging order information is used as the imaging part to be used to determine the automatic adjustment reference, the controller 21 can determine the automatic adjustment reference based on the information set at the time of imaging.

Further, the controller 21 can determine, for each item of the items such as the automatic rotation reference and the automatic trimming reference, the automatic adjustment reference on the basis of the imaging part.

Specifically, whether or not to perform the automatic adjustment and the automatic adjustment reference can be set in advance for each imaging part in the setting table 221 in accordance with an agreement in a medical facility or for each doctor.

Further, since the controller 21 calculates the adjustment amount (the rotation amount, the shift amount, or the like) in accordance with the automatic adjustment reference based on the structure recognized from the medical image, the controller 21 can perform the adjustment in conformity with the actual state of the image.

Further, by using the learned model M obtained by machine learning as the recognition section that automatically recognizes a structure of a subject in a medical image, the structure can be automatically recognized with high accuracy.

Note that the present invention is not limited to the above-described embodiment and can be appropriately modified without departing from the scope of the present invention.

Although the case where the functions of the medical image output apparatus according to the present invention are incorporated in the console 2 has been described in the above embodiment, the functions of the medical image output apparatus may be incorporated in an apparatus different from the console 2. Alternatively, a dedicated apparatus having the functions of the medical image output apparatus may be installed.

In the embodiment described above, the controller 21 of the console 2 causes the display part 24 to display an automatically adjusted image. Alternatively, the controller 21 may cause a display apparatus separate from the console 2 to display an automatically adjusted image. The recognition section, the adjustment section, and the output section according to the present invention may be mounted on different apparatuses to configure a medical image output system.

Further, a plurality of types of automatic adjustment reference may be prepared for the same (one) imaging part in the setting table 221, and the controller 21 may switch the types thereof to be use in accordance with application thereof by a medical facility.

Further, the adjustment section of the present invention may be a learned model obtained by machine learning.

Further, although the rotation and the trimming have been described as the adjustment of the medical image in the above embodiment, the controller 21 may automatically adjust the gradation, the contrast, and the like of the medical image.

The computer-readable medium storing the program for executing each process is not limited to the above-described example, and a portable recording medium such as a CD-ROM can also be applied. In addition, a carrier wave may be applied as a medium for providing data of the program(s) via a communication line.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-074433 filed on Apr. 28, 2023 is incorporated herein by reference in its entirety.

What is claimed is:

1. A medical image output apparatus comprising:
a hardware processor that automatically recognizes a structure of a subject in a medical image and automatically adjusts the medical image based on the recognized structure; and
an outputter that outputs the adjusted medical image.

2. The medical image output apparatus according to claim 1, wherein the automatic adjustment of the medical image includes at least one of adjustment of a rotation angle of the medical image, position adjustment of a rotation center of the medical image, adjustment of trimming of the medical image, and position adjustment of a trimming center of the medical image.

3. The medical image output apparatus according to claim 1, wherein the automatic adjustment of the medical image is adjustment of a rotation angle of the medical image or position adjustment of a rotation center of the medical image.

4. The medical image output apparatus according to claim 1, wherein the hardware processor determines, based on the recognized structure or imaging order information on the medical image, an automatic adjustment reference for automatically adjusting the medical image.

5. The medical image output apparatus according to claim 4, wherein the automatic adjustment reference for the medical image includes at least one of a reference for adjustment of a rotation angle of the medical image, a reference for position adjustment of a rotation center of the medical image, a reference for adjustment of trimming of the medical image, and a reference for position adjustment of a trimming center of the medical image.

6. The medical image output apparatus according to claim 4, wherein the automatic adjustment reference for the medical image is a reference for adjustment of a rotation angle of the medical image or a reference for position adjustment of a rotation center of the medical image.

7. The medical image output apparatus according to claim 4, wherein the automatic adjustment reference is information indicating a shape of an imaging part as an imaging target or an anatomical part of the imaging part.

8. The medical image output apparatus according to claim 1, further comprising a storage where each imaging part as an imaging target is associated and stored with whether to automatically adjust the medical image,
wherein the hardware processor determines whether to perform the automatic adjustment based on an imaging part as the imaging target, the imaging part being the recognized structure, or imaging order information on the medical image.

9. The medical image output apparatus according to claim 1,
wherein the automatic adjustment has a plurality of items,
wherein the medical image output apparatus further comprises a storage where each imaging part as an imaging target is associated and stored with whether to perform each item of the plurality of items of the automatic adjustment, and
wherein the hardware processor determines whether to perform the each of the plurality of items of the automatic adjustment based on an imaging part as the imaging target, the imaging part being the recognized structure, or imaging order information on the medical image.

10. The medical image output apparatus according to claim 1, further comprising a storage where each imaging part as an imaging target is associated and stored with an automatic adjustment reference for automatically adjusting the medical image,
wherein the hardware processor determines the automatic adjustment reference based on an imaging part as the imaging target, the imaging part being the recognized structure, or imaging order information on the medical image.

11. The medical image output apparatus according to claim 1,
wherein an automatic adjustment reference for automatically adjusting the medical image has a plurality of items,
wherein the medical image output apparatus further comprises a storage where each imaging part as an imaging target is associated and stored with each item of the plurality of items of the automatic adjustment reference, and
wherein the hardware processor determines the each item of the plurality of items of the automatic adjustment reference based on an imaging part as the imaging target, the imaging part being the recognized structure, or imaging order information on the medical image.

12. The medical image output apparatus according to claim 1, wherein the medical image is a radiographic image.

13. The medical image output apparatus according to claim 1, wherein the hardware processor uses a learned model obtained by machine learning.

14. A non-transitory computer-readable recording medium storing a program that causes a computer to:
automatically recognize a structure of a subject in a medical image;
automatically adjust the medical image based on the recognized structure, and
output the adjusted medical image.

15. The non-transitory computer-readable recording medium according to claim 14, wherein the automatic adjustment of the medical image includes at least one of adjustment of a rotation angle of the medical image, position adjustment of a rotation center of the medical image, adjustment of trimming of the medical image, and position adjustment of a trimming center of the medical image.

16. The non-transitory computer-readable recording medium according to claim 14, wherein the automatic adjustment of the medical image is adjustment of a rotation angle of the medical image or position adjustment of a rotation center of the medical image.

17. The non-transitory computer-readable recording medium according to claim 14, wherein the program further causes the computer to determine, based on the recognized structure or imaging order information on the medical image, an automatic adjustment reference for automatically adjusting the medical image.

18. The non-transitory computer-readable recording medium according to claim 17, wherein the automatic adjustment reference for the medical image includes at least one of a reference for adjustment of a rotation angle of the medical image, a reference for position adjustment of a rotation center of the medical image, a reference for adjustment of trimming of the medical image, and a reference for position adjustment of a trimming center of the medical image.

19. The non-transitory computer-readable recording medium according to claim 17, wherein the automatic adjustment reference for the medical image is a reference for adjustment of a rotation angle of the medical image or a reference for position adjustment of a rotation center of the medical image.

20. The non-transitory computer-readable recording medium according to claim 17, wherein the automatic adjustment reference is information indicating a shape of an imaging part as an imaging target or an anatomical part of the imaging part.

21. The non-transitory computer-readable recording medium according to claim 14, wherein the program further causes the computer to:
store each imaging part as an imaging target in association with whether to automatically adjust the medical image; and
determine whether to perform the automatic adjustment based on an imaging part as the imaging target, the imaging part being the recognized structure, or imaging order information on the medical image.

22. The non-transitory computer-readable recording medium according to claim 14,
wherein the automatic adjustment has a plurality of items, and
wherein the program further causes the computer to:
store each imaging part as an imaging target in association with whether to perform each item of the plurality of items of the automatic adjustment; and
determine whether to perform the each of the plurality of items of the automatic adjustment based on an imaging part as the imaging target, the imaging part being the recognized structure, or imaging order information on the medical image.

23. The non-transitory computer-readable recording medium according to claim 14, wherein the program further causes the computer to:
store each imaging part as an imaging target in association with an automatic adjustment reference for automatically adjusting the medical image; and
determine the automatic adjustment reference based on an imaging part as the imaging target, the imaging part being the recognized structure, or imaging order information on the medical image.

24. The non-transitory computer-readable recording medium according to claim 14,
wherein an automatic adjustment reference for automatically adjusting the medical image has a plurality of items, and
wherein the program further causes the computer to:
store each imaging part as an imaging target in association with each item of the plurality of items of the automatic adjustment reference; and
determine the each item of the plurality of items of the automatic adjustment reference based on an imaging part as the imaging target, the imaging part being the recognized structure, or imaging order information on the medical image.

25. The non-transitory computer-readable recording medium according to claim 14, wherein the medical image is a radiographic image.

26. The non-transitory computer-readable recording medium according to claim 14, wherein the computer uses a learned model obtained by machine learning.

27. A medical image output method comprising:
automatically recognizing a structure of a subject in a medical image;
automatically adjusting the medical image based on the recognized structure; and
outputting the adjusted medical image.

28. A medical image output system comprising:
a hardware processor that automatically recognizes a structure of a subject in a medical image and automatically adjusts the medical image based on the recognized structure; and
an outputter that outputs the adjusted medical image.
